(19) United States
(12) Patent Application Publication
(10) Pub. No.: US 2025/0385724 A1
(43) Pub. Date: Dec. 18, 2025

(54) RELAY COMMUNICATION METHOD AND APPARATUS, DEVICE, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/879,133

(22) PCT Filed: Jun. 28, 2022
(86) PCT No.: PCT/CN2022/102046

§ 371 Date: Dec. 26, 2024

(51) Int. Cl. H04B 7/06; H04B 7/15

(52) U.S. Cl. CPC H04B 7/06952; H04B 7/15

(57) ABSTRACT

The present invention relates to the technical field of communications, and particularly provides a relay communication method and apparatus, a device, and a storage medium, The method comprises: a relay device receives first indication information from a network device, the first indication information being used for indicating a beam state of a first beam of the relay device (S201); the relay device determines the beam state of the first beam according to the first indication information (S202). According to the technical solution of the present invention, beam-based interference management of an NCR can be achieved, and energy efficiency can be improved.

### TECHNICAL FILED

The present disclosure relates to the field of communication technology and, in particular, to a relay communication method, apparatus, device and storage medium.

### BACKGROUND

Coverage is a fundamental aspect of cellular network deployment. Mobile operators rely on different types of network nodes to provide full coverage in their deployments, especially as the carrier band increases, resulting in greater loss of radio signals in space. Deploying conventional full-stack units is an option, but it may not always be feasible.

The 3rd generation Partnership Project (3GPP) has considered the use of new types of network nodes, such as network-controlled repeaters (NCRs), to increase the flexibility for the mobile operators in their network deployments. In high-frequency band network deployments, beamforming technology is typically used to concentrate antenna energy within a specific area, thereby enhancing the received signal strength for users and reducing interference to other users.

Therefore, how to realize beam-based interference management and improve energy efficiency for NCR is an urgent issue to be addressed.

### SUMMARY

The present disclosure provides a relay communication method, apparatus, device, and storage medium to enable beam-based interference management and improve energy efficiency for NCRs.

In a first aspect, the present disclosure provides a relay communication method that can be applied to a relay device, such as an NCR. The method can include: receiving, by a relay device, first indication information from a network device, wherein the first indication information is configured for indicating a beam state of a first beam of the relay device; and determining, by the relay device, the beam state of the first beam based on the first indication information.

In some possible implementations, the beam state can be an activated state or a deactivated state; and the activated state indicates that a beam is available for transmission and the deactivated state indicates that a beam is not available for transmission.

In some possible implementations, when the beam state is the deactivated state, the method described above can further include: determining, by the relay device, that the first beam is not included in the beam indication information sent by the network device; or, determining, by the relay device, that the first beam is not included in the beam indication information sent by the network device within a first duration.

In some possible implementations, the first beam can include at least one of: one or more beams and/or one or more beam groups of a backhaul link of the relay device; one or more beams and/or one or more beam groups of a control link of the relay device; or one or more beams and/or one or more beam groups of an access link of the relay device.

In some possible implementations, the operation of the relay device determining the beam state of the first beam based on the first indication information, can include: changing, by the relay device, the beam state of the first beam from a first state to a second state based on the first indication information, the first state being different from the second state.

In some possible implementations, the operation of the relay device determining the beam state of the first beam based on the first indication information, can include: setting, by the relay device, the beam state of the first beam to a third state based on the first indication information

In some possible implementations, the first indication information can be carried in Downlink Control Information (DCI).

In some possible implementations, the method described above can further include: determining, by the relay device, a second duration between the reception of the first indication information and the time when the beam state becomes effective on the first beam; or, determining, by the relay device, a third duration between sending of an acknowledgement message for the first indication information and the time when the beam state becomes effective on the first beam.

In some possible implementations, the first beam can be associated with activation configuration information. The activation configuration information can be configured for indicating the beam state of the first beam over at least one time unit. The first indication information can include the activation configuration information. The operation of the relay device determining the beam state of the first beam based on the first indication information, can include: setting, by the relay device, the beam state over the at least one time unit based on the activation configuration information.

In some possible implementations, the first indication information can be carried in Radio Resource Control (RRC) signaling.

In some possible implementations, the first beam can be associated with a plurality pieces of activation configuration information. Each piece of activation configuration information can be configured for indicating the beam state of the first beam over at least one time unit. The first indication information can be configured for indicating one or more pieces of first activation configuration information in the plurality of pieces of activation configuration information. The operation of the relay device determining the beam state of the first beam based on the first indication information, can include: setting, by the relay device, the beam state over the at least one time unit based on the one or more pieces of first activation configuration information.

In some possible implementations, the first indication information can be carried in a Media Access Control Control Element (CE) or DCI.

In some possible implementations, the activation configuration information can include at least one of: a pattern; an effective moment of the pattern; or an effective duration of the pattern.

In some possible implementations, the method described above can further include: setting, by the relay device, an initial beam state of the first beam to an activated state or a deactivated state.

In a second aspect, the present disclosure provides a relay communication method that can be applied to a network device. The method can include: determining, by a network device, a beam state of a first beam of a relay device; and sending, by the network device, first indication information to the relay device, wherein the first indication information is configured for indicating the beam state.

In some possible implementations, the beam state is an activated state or a deactivated state; and the activated state indicates that a beam is available for transmission and the deactivated state indicates that a beam is not available for transmission.

In some possible implementations, when the beam state is the deactivated state, the first beam is not included in beam indication information sent by the network device; or the first beam is not included in the beam indication information sent by the network device within a first duration.

In some possible implementations, the first beam can include at least one of: one or more beams and/or one or more beam groups of a backhaul link of the relay device; one or more beams and/or one or more beam groups of a control link of the relay device; or one or more beams and/or one or more beam groups of an access link of the relay device.

In some possible implementations, the first indication information can be configured for indicating a change in setting the beam state from a first state to a second state, the first state being different from the second state.

In some possible implementations, the first indication information can be configured for indicating a setting of the beam state to a third state.

In some possible implementations, the first indication information can be carried in the DCI.

In some possible implementations, the first beam can be associated with activation configuration information. The activation configuration information can be configured for indicating the beam state of the first beam over at least one time unit. The first indication information can include the activation configuration information.

In some possible implementations, the first indication information can be carried in RRC signaling.

In some possible implementations, the first beam can be associated with a plurality pieces of activation configuration information. Each piece of activation configuration information can be configured for indicating the beam state of the first beam over at least one time unit. The first indication information can be configured for indicating one or more pieces of first activation configuration information in the plurality of pieces of activation configuration information.

In some possible implementations, the first indication information can be carried in a MAC CE or DCI.

In some possible implementations, the activation configuration information can include at least one of: a pattern; an effective moment of the pattern; or an effective duration of the pattern.

In some possible implementations, an initial beam state of the first beam can be an activated state or a deactivated state.

In a third aspect, the present disclosure provides a relay communication device. The device may be a relay device or a chip or a system-on-chip in the relay device, and may also be a functional module in the relay device for implementing the method described in the above first aspect. The relay communication device may realize functions performed by the relay device in the above-described first aspect, and these functions may be realized by hardware executing corresponding software. Such hardware or software includes one or more modules corresponding to the functions described above. The above-described device includes: a receiving module configured to receive first indication information from a network device, wherein the first indication information is configured for indicating a beam state of a first beam of a relay device; and a processing module configured to determine the beam state of the first beam based on the first indication information.

In some possible implementations, the beam state can be an activated state or a deactivated state; and the activated state indicates that a beam is available for transmission and the deactivated state indicates that a beam is not available for transmission.

In some possible implementations, the processing module can further be configured to: when the beam state is the deactivated state, determine that the first beam is not included in the beam indication information sent by the network device; or, determine that the first beam is not included in the beam indication information sent by the network device within a first duration.

In some possible implementations, the first beam can include at least one of: one or more beams and/or one or more beam groups of a backhaul link of the relay device; one or more beams and/or one or more beam groups of a control link of the relay device; or one or more beams and/or one or more beam groups of an access link of the relay device.

In some possible implementations, the processing module can be configured to: change the beam state of the first beam from a first state to a second state based on the first indication information, the first state being different from the second state.

In some possible implementations, the processing module can be configured to: set the beam state of the first beam to a third state based on the first indication information.

In some possible implementations, the first indication information can be carried in DCI.

In some possible implementations, the processing module can also be configured to: determine a second duration between the reception of the first indication information and the time when the beam state becomes effective on the first beam; or, determine a third duration between sending of an acknowledgement message for the first indication information and the time when the beam state becomes effective on the first beam.

In some possible implementations, the first beam can be associated with activation configuration information. The activation configuration information can be configured for indicating the beam state of the first beam over at least one time unit. The first indication information can include the activation configuration information. The processing module can be configured to: set the beam state over the at least one time unit based on the activation configuration information.

In some possible implementations, the first indication information can be carried in RRC signaling.

In some possible implementations, the first beam can be associated with a plurality pieces of activation configuration information. Each piece of activation configuration information can be configured for indicating the beam state of the first beam over at least one time unit. The first indication information can be configured for indicating one or more pieces of first activation configuration information in the plurality of pieces of activation configuration information. The processing module can be configured to set the beam state over the at least one time unit based on the one or more pieces of first activation configuration information.

In some possible implementations, the first indication information can be carried in a MAC CE or DCI.

In some possible implementations, the activation configuration information can include at least one of: a pattern; an effective moment of the pattern; or an effective duration of the pattern.

In some possible implementations, the processing module can also be configured to: set an initial beam state of the first beam to an activated state or a deactivated state.

In a fourth aspect, the present disclosure provides a relay communication device. The device may be a network device or a chip or a system-on-chip in the network device, and may also be a functional module in the network device for implementing the method described in the first aspect above. The relay communication device may realize functions performed by the network device in the above-described first aspect, and these functions may be realized by hardware executing corresponding software. Such hardware or software includes one or more modules corresponding to the functions described above. The above-described device includes: a processing module configured to determine a beam state of a first beam of a relay device; and a sending module configured to send first indication information to the relay device, wherein the first indication information is configured for indicating the beam state.

In some possible implementations, the beam state can be an activated state or a deactivated state; and the activated state indicates that a beam is available for transmission and the deactivated state indicates that a beam is not available for transmission.

In some possible implementations, when the beam state is the deactivated state, the first beam is not included in beam indication information sent by the network device; or the first beam is not included in the beam indication information sent by the network device within a first duration.

In some possible implementations, the first beam can include at least one of: one or more beams and/or one or more beam groups of a backhaul link of the relay device; one or more beams and/or one or more beam groups of a control link of the relay device; or one or more beams and/or one or more beam groups of an access link of the relay device.

In some possible implementations, the first indication information can be configured for indicating a change in setting the beam state from a first state to a second state, the first state being different from the second state.

In some possible implementations, the first indication information can be configured for indicating a setting of the beam state to a third state.

In some possible implementations, the first indication information can be carried in the DCI.

In some possible implementations, the first beam can be associated with activation configuration information. The activation configuration information can be configured for indicating the beam state of the first beam over at least one time unit. The first indication information can include the activation configuration information.

In some possible implementations, the first indication information can be carried in RRC signaling.

In some possible implementations, the first beam can be associated with a plurality pieces of activation configuration information. Each piece of activation configuration information can be configured for indicating the beam state of the first beam over at least one time unit. The first indication information can be configured for indicating one or more pieces of first activation configuration information in the plurality of pieces of activation configuration information.

In some possible implementations, the first indication information can be carried in a MAC CE or DCI.

In some possible implementations, the activation configuration information can include at least one of: a pattern; an effective moment of the pattern; or an effective duration of the pattern.

In some possible implementations, an initial beam state of the first beam can be an activated state or a deactivated state.

In a fifth aspect, the present disclosure provides an electronic device. The electronic device includes: a memory and a processor connected to the memory and configured to execute computer-executable instructions stored on the memory to implement a method as described in any one of the first aspect, the second aspect, and possible embodiments thereof.

In a sixth aspect, the present disclosure provides a computer storage medium. The computer storage medium stores computer executable instructions. The computer-executable instructions, when executed by a processor, are capable of realizing a method as described in any one of the first aspect, the second aspect, and possible embodiments thereof.

In the present disclosure, the network device can send first indication information for indicating a beam state to the relay device to enable the relay device to set a beam state of a corresponding beam based on the first indication information. In this way, the network device is able to control the beam state of the relay device. Specifically, the present disclosure adopts an activated/deactivated state or an activation/deactivation pattern for explicit indication of a beam state, thereby enabling efficient control of activation/deactivation of a beam of the relay device, reducing power consumption of the relay device, and improving energy efficiency. In addition, interference of the relay device to neighboring cells can be reduced, and beam-based interference management can be achieved.

It should be understood that the third to sixth aspects of the present disclosure are consistent with the technical solutions of the first and second aspects of the present disclosure, and the beneficial effects achieved by each aspect and corresponding feasible embodiments are similar and will not be repeated.

### BRIEF DESCRIPTION OF THE DRAWINGS

FIG. 1 is a schematic diagram of a model of an NCR according to embodiments of the present disclosure.

FIG. 2 is a flowchart of a relay communication method according to embodiments of the present disclosure.

FIG. 3 is a flowchart of another relay communication method according to embodiments of the present disclosure.

FIG. 4 is a schematic diagram of a structure of a relay communication device according to embodiments of the present disclosure.

FIG. 5 is a schematic diagram of a structure of another relay communication device according to embodiments of the present disclosure.

FIG. 6 is a schematic diagram of a structure of a communication device according to embodiments of the present disclosure.

FIG. 7 is a schematic diagram of a structure of a network device according to embodiments of the present disclosure.

### DETAILED DESCRIPTION

Exemplary embodiments will be described herein in detail, examples of which are represented in the accompanying drawings. When the following description relates to the accompanying drawings, the same numerals in the different accompanying drawings indicate the same or similar elements unless otherwise indicated. The examples described in the following exemplary embodiments do not represent all of the examples consistent with the embodiments of the present disclosure. Rather, they are only examples of devices and methods consistent with some aspects of embodiments of the present disclosure as detailed in the appended claims.

Terms used in this disclosure are used solely for the purpose of describing particular embodiments and are not intended to limit this disclosure. The singular forms “a/an” and “the” as used in this disclosure and in the appended claims are also intended to encompass the plural forms, unless the context clearly indicates otherwise. It should also be understood that the term “and/or” as used herein refers to and encompasses any or all possible combinations of one or more of the associated listed items.

It should be understood that while the terms “first,” “second,” “third,” etc. may be used in embodiments of the present disclosure to describe various types of information, such information should not be limited to these terms. These terms are only used to distinguish information of the same type from one another. For example, without departing from the scope of the embodiments of the present disclosure, “first information” may also be referred to as “second information,” and similarly, “second information” may be referred to as “first information.” Depending on the context, the phrase “if” as used herein may be interpreted as “at the time of . . . ” or “when . . . ” or “in response to . . . ”

Further, in the description of embodiments of the present disclosure, “and/or” is merely used to describe an associative relationship between associated objects, indicating that there can be three possible relationships. For example, “A and/or B” can represent three scenarios: A alone, A and B together, or B alone. In addition, in the description of embodiments of the present disclosure, “multiple/a plurality of” can refer to two or more than two.

Coverage is a fundamental aspect of cellular network deployment. Mobile operators rely on deploying different types of network nodes to provide full coverage. Deploying conventional full-stack units is an option, but it may not always be feasible (e.g., no backhaul) or economically viable.

Therefore, new types of network nodes have been considered to increase the flexibility for mobile operators in their network deployments. For example, integrated access and backhaul (IAB) functionality was introduced in Release 16 (Rel-16) and enhanced in Release 17 (Rel-17) as a new type of network node that does not require wired backhaul. Another type of network node is the radio frequency (RF) repeater, capable of simply amplifying and forwarding any signal received. RF repeaters have been widely deployed, thus complementing the coverage provided by conventional full-stack units.

While RF repeaters provide a cost-effective way to extend network coverage, they have their limitations. RF repeaters simply perform amplification and forwarding operations without considering various factors that could enhance performance, such as those related to semi-static and/or dynamic downlink/uplink configurations, adaptive transmitter/receiver spatial beamforming, on-off states, etc.

Therefore, the traditional RF repeater is augmented to obtain a network control repeater, i.e., NCR. The NCR has the ability to receive and process side control information from the network. The side control information may allow the network control repeater to perform its amplification and forwarding operations in a more efficient manner. Potential benefits may include mitigation of unwanted noise amplification, transmission and reception with better spatial directionality, and simplified network integration.

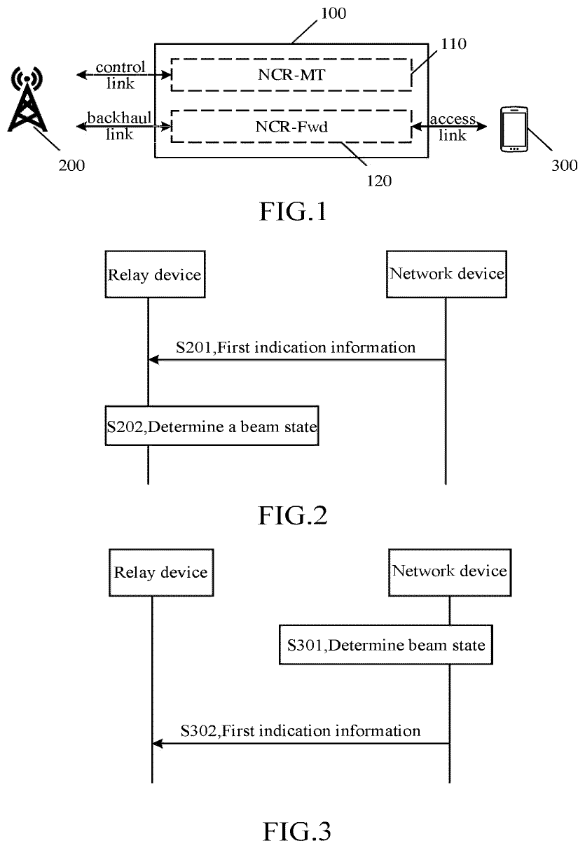

FIG. 1 shows a schematic diagram of a structure of an NCR according to embodiments of the present disclosure. As shown in FIG. 1, an NCR 100 may include an NCR-mobile termination (NCR-MT) module 110 and an NCR-forwarding (NCR-Fwd) module 120. The NCR-MT module 110 may establish a control link (or C-link) with a network device 200. The NCR-Fwd module 120 may establish a backhaul link with the network device 200 and may establish an access link with a terminal device 300. In this way, forwarding of uplink data and/or downlink data can be realized.

The control link is used to realize the transmission of control signaling between the NCR 100 and the network device 200, so as to control the backhaul link and the control link between the NCR 100 and the network device 200, and the access link between the NCR 100 and the terminal device 300.

In an embodiment, the aforementioned terminal device 300 can be a terminal device with wireless communication capabilities, also referred to as user equipment (UE). The terminal device can be deployed on land, including indoors or outdoors, as handheld, wearable, or vehicle-mounted devices; it can also be deployed on water surfaces (such as ships); and it can even be deployed in the air (such as on airplanes, balloons, and satellites). The aforementioned terminal device can be a mobile phone, tablet (Pad), computer with wireless transceiver functionality, virtual reality (VR) terminal, augmented reality (AR) terminal, wireless terminal in industrial control, wireless terminal in self-driving vehicles, wireless terminal in remote medical applications, wireless terminal in smart grids, wireless terminal in transportation safety, wireless terminal in smart cities, wireless terminal in smart homes, and so on. The terminal device can also be a handheld device, vehicle-mounted device, wearable device, computing device, or other processing device connected to a wireless modem with wireless communication capabilities. Optionally, in different networks, the terminal device may also be known by different names, such as: terminal, access terminal, user unit, user station, mobile station, mobile terminal, remote station, remote terminal, mobile device, user terminal, terminal equipment, wireless communication device, user agent or user apparatus, cellular phone, cordless phone, Session Initiation Protocol (SIP) phone, Wireless Local Loop (WIL) station, Personal Digital Assistant (PDA), terminal device in 5G networks or future evolved networks, and so forth.

The aforementioned network device 200 can be an access network device, and further can be a device on the access network side used to support terminal access to the wireless communication system. For example, it can be a next generation NodeB (gNB), transmission reception point (TRP), relay node, access point (AP), or other such devices in a communication system based on a 5G access technology.

In embodiments of the present disclosure, the beam of the aforementioned NCR 100 may include three portions. A first portion of the beam is used for the control link, which may also be described as a beam at NCR for control link, a control link beam or a beam of control link, and the like. A second portion of the beam is used for the backhaul link, which can also be described as a beam at NCR for backhaul link, a backhaul link beam or a beam of backhaul link, and the like. A third portion of the beam is used for the access link, which can also be described as a beam at NCR for backhaul link, an access link beam or a beam of access link, and the like.

It should be noted that since both the control link and the backhaul link are links established between the NCR 100 and the network device 200, the control link and the backhaul link can reuse (or share) one or more beams. Therefore, it is understandable that the beam of the control link and the beam of the backhaul link may be completely different beams, partially different beams, or even exactly the same beam, and embodiments of the present disclosure do not specifically limit this.

In embodiments of the present disclosure, “beam” can be understood as one or more beams or as one or more beam groups. In this case, “beam identification information” can be understood as identification information of a beam, or as identification information of a beam group.

In some possible implementations, the aforementioned beams can be predefined in the communication protocol or can be indicated by the network device 200. The network device 200 may indicate the beam by one or more of: beam identification information (e.g., beam ID or beam group ID), or signal identification information (e.g., RS ID) of a reference signal (RS) associated with the beam.

However, in practice, the beams of the NCR may have the potential to cause interference to neighboring cells. Furthermore, since the transmission of each beam consumes a certain amount of energy, continuing to keep transmitting all beams when the amount of forwarded data is not large will result in a waste of energy. Therefore, how to realize the energy saving and interference management based on beam management for NCR is an urgent issue to be addressed.

To address the aforementioned issues, embodiments of the present disclosure provide a relay communication method. The method can be applied to a relay device, such as an NCR. FIG. 2 is a flowchart of a relay communication method according to embodiments of the present disclosure. As shown in FIG. 2, the method may include S201 and S202.

S201, receiving, by a relay device, first indication information from a network device (e.g., a base station).

The first indication information is configured for indicating a beam state of a first beam of the relay device.

Understandably, the beam state of the first beam can refer to whether the first beam is activated or not. In an embodiment, the beam of the relay device may have two beam states: an activated state and a deactivated state. The activated state indicates that the beam is available for transmission. The deactivated state indicates that the beam is not available for transmission. It should be noted that the activated state may refer to that the relay device transmits the beam, and the beam transmitted by the relay device is the beam that is available for transmission; the deactivated stat may refer to that the relay device does not transmit the beam, and the beam not transmitted by the relay device is the beam that is not available for transmission. Therefore, the two states of the beam can be expressed in other ways. For example, the activated state can also be referred to as the “on” state or “enabled” state, and the deactivated state can also be referred to as the “off” state or “disabled” state.

In an embodiment, the aforementioned first beam can include at least one of the following: one or more beams and/or beam groups of a backhaul link; one or more beams and/or beam groups of a control link; or one or more beams and/or beam groups of an access link.

In an embodiment, the first indication information can include a beam identifier of the first beam, and/or a target state of the first beam. The beam identifier is used to identify the first beam. The target state is a state that the network device instructs the relay device to set the first beam to. For example, if the target state is an activated state, it means that the beam state indicated by the first indication information is an activated state; if the target state is a deactivated state, it means that the beam state indicated by the first indication information is a deactivated state.

In some possible implementations, the first indication information can be used to indicate the setting of the beam state. In an implementation, the first indication information may contain a beam identifier. In this case, the target state can (implicitly) be a second state different from a first state. The first state can be the current state of the first beam. If the first state is one of an activated state and a deactivated state, the second state is the other state among the activated state and the deactivated state.

In some possible implementations, the first indication information can be used to indicate the setting of the beam state to a third state. In an implementation, the first indication information may contain a beam identifier and a target state. The target state may be a third state. The third state may be any one of an activated state and a deactivated state. In an implementation, the first indication information may contain a target state. In this case, the first beam may be all of the beams and/or beam groups of the backhaul link and/or the control link and/or the access link of the relay device.

It is understandable that in the embodiments of this disclosure, operations such as “determining,” “setting,” “configuring,” “changing,” “modifying,” etc., can be considered as operations of the same or similar type when necessary.

It should be noted that in this embodiment, the first indication information can be carried in Downlink control information (DCI).

In another embodiment, the first indication information can be used to indicate an activation configuration for the first beam. In this case, the first beam can be associated with activation configuration information. The activation configuration information can be used to indicate a beam state of the first beam over at least one time unit. The first indication information may include activation configuration information. The time unit herein may be a frame, a sub-frame, a slot, a sub-slot, a symbol, and the like.

In some possible implementations, the activation configuration information may include one of the following: a pattern, an effective moment of the pattern, or an effective duration of the pattern. The pattern is a configuration for the activation/deactivation of the first beam. The effective moment of the pattern is the moment when the beam state of the first beam starts to follow the pattern configuration. The effective duration of the pattern is the duration for which the pattern is applied to the first beam.

In practice, the pattern can be represented in binary form. For example, the pattern may be “1110001,” wherein “0” and “1” may indicate a deactivated state and an active state, respectively. In this case, the pattern “1110001” indicates that the beam states of the first beam over seven consecutive time units are, in order: activated, activated, activated, deactivated, deactivated, deactivated, activated.

In practice, the pattern can also be represented in terms of the duration of the state. For example, the pattern can be represented by a number of time units during which the beam is activated and/or a number of time units during which the beam is deactivated. In this case, a plurality of time units may be included within the length of time that the pattern lasts, wherein the beam is activated during the preceding one or more time units and/or the beam is deactivated during the following one or more time units.

In some possible implementations, the pattern can be applied only once, or repeatedly, when applied to the first beam. Accordingly, an effective duration of the pattern can be included in the first indication information. The effective duration can be represented by time, the number of repetitions, or other means. In an example, the effective duration may be represented by the application time of the pattern. For instance, the effective duration may be represented by a number of units of time, or may be represented by a length of time. In another example, the effective duration may be represented by the number of times the pattern is applied.

It should be noted that in this embodiment, the first indication information can be carried in Radio Resource Control (RRC) signaling.

Furthermore, it is understandable that the first beam can be associated with a plurality of pieces of activation configuration information. Each piece of activation configuration information can be used to indicate a beam state of the first beam over at least one time unit. The first indication information is used to indicate one or more pieces of first activation configuration information among the plurality of pieces of activation configuration information. For example, the first indication information may include said one or more pieces of first activation configuration information, or the first indication information may include identifier(s) of said one or more pieces of first activation configuration information.

It should be noted that in this embodiment, the first indication information can be carried on a Medium Access Control Control Element (MAC CE) or DCI.

S202, determining, by the relay device, the beam state of the first beam based on the first indication information.

After receiving the first indication information in S201, the relay device sets the beam state of the first beam based on the first indication information.

In an embodiment, the relay device sets the beam state of the first beam based on the first indication information in a manner that may be specifically as follows.

In an implementation, the first indication information can be used to indicate the setting of the beam state. Specifically, S202 can be: the relay device sets the beam state of the first beam from a first state to a second state based on the first indication information.

In an implementation, the first indication information can be used to indicate the setting of the beam state to a third state. Specifically, S202 can be: the relay device sets the beam state of the first beam to the third state based on the first indication information.

In an embodiment, there may be a delay between the reception of the first indication information by the relay device and the completion of the beam state setting of the first beam by the relay device. In practice, the delay can be determined based on transmission performance between the relay device and the network device, equipment parameters of the relay device, and other parameters.

In an implementation, the relay device can determine that the first indication information has been received for a second duration. That is, after the relay device receives the first indication information, it starts to count the second duration. When the countdown reaches the second duration, the relay device completes S202. In other words, when the countdown reaches the second duration, the beam state indicated by the first indication information becomes effective on the first beam.

In an implementation, the method may further include: sending, by the relay device, an acknowledgement message to the network device in response to the first indication information. The acknowledgement message is used to confirm receipt of the first indication information to the network device. In this case, the relay device can determine that the acknowledgment message has been sent for a third duration. That is, after the relay device sends the acknowledgment message, it starts to count the third duration. When the countdown reaches the third duration, the relay device completes S202. In other words, when the countdown reaches the third duration, the beam state indicated by the first indication information becomes effective on the first beam.

In some possible implementations, the second duration and the third duration can be independent of each other. Under normal circumstances, the relay device may only consider either the second duration or the third duration. However, it is understandable that the relay device can take both the second duration and the third duration into consideration. For example, the relay device may complete S202 when both the second duration and the third duration have been reached. Alternatively, the relay device may complete S202 when either the second duration or the third duration has been reached.

In an embodiment, when the beam state is the deactivated state, the method may further include: determining, by the relay device, that the first beam is not included in the beam indication information sent by the network device; or, determining, by the relay device, that the first beam is not included in the beam indication information sent by the network device within a first duration. As mentioned above, the beam state of each beam of the relay device is known to the network device. Therefore, when the beam state of the first beam is the deactivated state, the relay device can determine that the network device does not use the first beam for transmission, that is, the beam indication information indicating the beams for transmission does not include the first beam. Alternatively, when the beam state of the first beam is the deactivated state, the relay device can determine that the network device does not use the first beam for transmission within the first duration, that is, the beam indication information indicating the beams for transmission does not include the first beam.

In another embodiment, the relay device sets the beam state of the first beam based on the first indication information in a manner that may be specifically as follows.

In an implementation, the first indication information can be used to indicate an activation configuration of the first beam and that the first beam is associated with the activation configuration information. The relay device can set the beam state of the first beam based on the first indication information. For example, in the case where the first indication information includes a pattern, the relay device can set the beam state of the first beam in accordance with the pattern. For another example, in the case where the first indication information includes a pattern and an effective moment, the relay device can set the beam state of the first beam from the effective moment, in accordance with the pattern. Yet another example is that, in the case where the first indication information includes a pattern and an effective duration, the relay device can set the beam state of the first beam to follow the pattern within the effective duration. Furthermore, if the first indication information includes a pattern, an effective moment, and an effective duration, the relay device can set the beam state of the first beam to follow the pattern within the effective duration starting from the effective moment.

In one implementation, the first indication information can be used to indicate an activation configuration of the first beam and that the first beam is associated with a plurality of pieces of activation configuration information. The relay device can set the beam state of the first beam based on the first indication information. For example, in the case where the first indication information includes an identifier of the first activation configuration information, the relay device can determine, from the plurality of pieces of activation configuration information for the first beam, first activation configuration information corresponding to the identifier, and use the first activation configuration information to set the beam state of the first beam.

Furthermore, in practice, the beam of the relay device usually has an initial beam state. In an embodiment, the above method may further include: setting, by the relay device, the initial beam state of the first beam to an activated state or a deactivated state. It is understandable that the initial beam state of the first beam can be set by default, i.e., set directly by the relay device at power-up.

Embodiments of the present disclosure also provide a relay communication method, which can be applied to a network device. FIG. 3 is a flowchart of the relay communication method according to the embodiments of the present disclosure. As shown in FIG. 3, the method may include S301 and S302.

S301, determining, by a network device, a beam state of a first beam of a relay device.

In this case, the network device first determines how it will set the beam state of the first beam.

It is understandable that the network device can determine a beam state of the first beam based on at least one or more of the following information: a data volume of a backhaul link of the relay device, a quality parameter of the backhaul link, a data volume of an access link of the relay device, a quality parameter of the access link, and the like. This information can be fed back from the relay device to the network device. Of course, the data volume of the backhaul link and the data volume of the access link can sometimes be equal, and the network device can directly obtain the data volume of the backhaul link. In this case, the relay device can only feed back quality parameters to the network device. It should be noted that the basis for the network device to determine the beam state of the first beam may also include other information, which is not limited in embodiments of the present disclosure.

In an embodiment, the beam of the relay device may have two beam states: an activated state and a deactivated state. The activated state indicates that the beam is available for transmission. The deactivated state indicates that the beam is not available for transmission. It should be noted that the activated state may refer to that the relay device transmits the beam, and the beam transmitted by the relay device is the beam that is available for transmission; the deactivated stat may refer to that the relay device does not transmit the beam, and the beam not transmitted by the relay device is the beam that is not available for transmission. Therefore, the two states of the beam can be expressed in other ways. For example, the activated state can also be referred to as the “on” state or “enabled” state, and the deactivated state can also be referred to as the “off” state or “disabled” state.

It should be noted that the beam states of the beams of the relay device are known to the network device. Specifically, at the time the network device determines the beam state of the first beam, the network device can know the current beam state of each beam of the relay device.

In an embodiment, an initial beam state of the first beam of the relay device can be an activated state or a deactivated state. And, the initial beam state of the first beam can be known to the network device. For example, the network device can by default consider the initial beam state of the first beam of the relay device to be an activated state.

In an embodiment, in the case where the beam state of the first beam is a deactivated state, the beam indication information sent by the network device does not include the first beam; or, the beam indication information sent by the network device within a first duration does not include the first beam.

S302, sending, by the network device, first indication information to the relay device.

The first indication information is configured for indicating the beam state of the first beam.

In an embodiment, the first beam of the relay device associated with the first indication information can include at least one of the following: one or more beams and/or beam groups of a backhaul link; one or more beams and/or beam groups of a control link; or one or more beams and/or beam groups of an access link.

In an embodiment, the first indication information can include a beam identifier of the first beam, and/or a target state of the first beam. The beam identifier is used to identify the first beam. The target state is a state that the network device instructs the relay device to set the first beam to.

In some possible implementations, the first indication information can be used to indicate the setting of the beam state. In an implementation, the first indication information may contain a beam identifier. In this case, the target state can (implicitly) be a second state different from a first state. The first state can be the current state of the first beam. If the first state is one of an activated state and a deactivated state, the second state is the other state among the activated state and the deactivated state.

In some possible implementations, the first indication information can be used to indicate the setting of the beam state to a third state. In an implementation, the first indication information may contain a beam identifier and a target state. The target state may be a third state. The third state may be any one of an activated state and a deactivated state. In an implementation, the first indication information may contain a target state. In this case, the first beam may be all of the beams and/or beam groups of the backhaul link and/or the control link and/or the access link of the relay device.

It should be noted that in this embodiment, the first indication information can be carried in the DCI. In this case, S302 may include: sending, by the network device, a Physical Downlink Control Channel (PDCCH) to the relay device. The DCI is carried in the PDCCH.

In another embodiment, the first indication information can be used to indicate an activation configuration for the first beam. In this case, the first beam can be associated with activation configuration information. The activation configuration information can be used to indicate a beam state of the first beam over at least one time unit. The first indication information may include activation configuration information. The time unit herein may be a frame, a sub-frame, a slot, a sub-slot, a symbol, and the like.

In some possible implementations, the activation configuration information may include one of the following: a pattern, an effective moment of the pattern, or an effective duration of the pattern. The pattern is a configuration for the activation/deactivation of the first beam. The effective moment of the pattern is the moment when the beam state of the first beam starts to follow the pattern configuration. The effective duration of the pattern is the duration for which the pattern is applied to the first beam.

In practice, the pattern can be represented in binary form. For example, the pattern may be “1110001,” wherein “0” and “1” may indicate a deactivated state and an active state, respectively. In this case, the pattern “1110001” indicates that the beam states of the first beam over seven consecutive time units are, in order: activated, activated, activated, deactivated, deactivated, deactivated, activated.

In some possible implementations, the pattern can be applied only once, or repeatedly, when applied to the first beam. Accordingly, an effective duration of the pattern can be included in the first indication information. The effective duration can be represented by time, the number of repetitions, or other means. In an example, the effective duration may be represented by the application time of the pattern. For instance, the effective duration may be represented by a number of units of time, or may be represented by a length of time. In another example, the effective duration may be represented by the number of times the pattern is applied.

It should be noted that in this embodiment, the first indication information can be carried on RRC signaling. In this case, S302 may include: sending, by the network device, RRC signaling to the relay device.

Furthermore, it is understandable that the first beam can be associated with a plurality of pieces of activation configuration information. Each piece of activation configuration information can be used to indicate a beam state of the first beam over at least one time unit. The first indication information is used to indicate one or more pieces of first activation configuration information among the plurality of pieces of activation configuration information. For example, the first indication information may include said one or more pieces of first activation configuration information, or the first indication information may include identifier(s) of said one or more pieces of first activation configuration information.

It should be noted that in this embodiment, the first indication information can be carried in a MAC CE or DCI. For example, in the case where the first indication information is carried in the MAC CE, S302 may include: sending, by the network device, the MAC CE to the relay device. For another example, in the case where the first indication information is carried in the DCI, S302 may include: sending, by the network device, a PDCCH to the relay device. The DCI is carried in the PDCCH.

In embodiments of the present disclosure, for a detailed description of the first indication information in the embodiment shown in FIG. 3, please refer to the description of the first indication information in the embodiment shown in FIG. 2.

In the embodiments of the present disclosure, the network device can send first indication information for indicating a beam state to the relay device to enable the relay device to set a beam state of a corresponding beam based on the first indication information. In this way, the network device is able to control the beam state of the relay device. Specifically, the present disclosure adopts an activated/deactivated state or an activation/deactivation pattern for explicit indication of a beam state, thereby enabling efficient control of activation/deactivation of a beam of the relay device, reducing power consumption of the relay device, and improving energy efficiency. In addition, interference of the relay device to neighboring cells can be reduced, and beam-based interference management can be achieved.

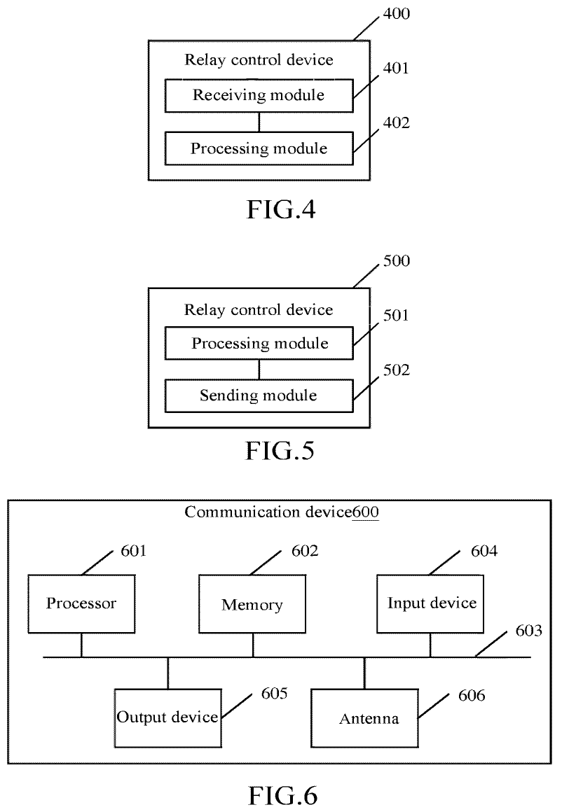

Based on the same inventive concept, embodiments of the present disclosure also provide a relay communication device. The device may be a relay device in the above-described communication system or a chip or a system-on-chip in the relay device, and may also be a functional module in the relay device for realizing the method described in the above embodiments. The device can realize functions performed by the relay device in the above embodiments, and these functions can be realized by executing corresponding software by hardware. Such hardware or software includes one or more modules corresponding to the above-described functions. FIG. 4 is a schematic diagram of a structure of a relay communication device according to embodiments of the present disclosure. As shown in FIG. 4, the relay communication device 400 can include a receiving module 401 and a processing module 402. The receiving module 401 is configured to receive first indication information from a network device. The first indication information is configured for indicating a beam state of a first beam of the relay device. The processing module 402 is configured to determine the beam state of the first beam based on the first indication information.

In some possible implementations, the beam state can be an activated state or a deactivated state; and the activated state indicates that a beam is available for transmission and the deactivated state indicates that a beam is not available for transmission.

In some possible implementations, the processing module 402 can further be configured to: when the beam state is the deactivated state, determine that the first beam is not included in the beam indication information sent by the network device; or, determine that the first beam is not included in the beam indication information sent by the network device within a first duration.

In some possible implementations, the first beam can include at least one of: one or more beams and/or one or more beam groups of a backhaul link of the relay device; one or more beams and/or one or more beam groups of a control link of the relay device; or one or more beams and/or one or more beam groups of an access link of the relay device.

In some possible implementations, the first indication information can be configured for indicating modification of the beam state. The processing module 402 can be configured to: change the beam state of the first beam from a first state to a second state based on the first indication information, the first state being different from the second state.

In some possible implementations, the first indication information can be configured for indicating a setting of the beam state to a third state. The processing module 402 can be configured to set the beam state of the first beam to a third state based on the first indication information.

In some possible implementations, the first indication information can be carried in DCI.

In some possible implementations, the processing module 402 can also be configured to: determine a second duration between the reception of the first indication information and the time when the beam state becomes effective on the first beam; or, determine a third duration between sending of an acknowledgement message for the first indication information and the time when the beam state becomes effective on the first beam.

In some possible implementations, the first beam can be associated with activation configuration information. The activation configuration information can be configured for indicating the beam state of the first beam over at least one time unit. The first indication information can include the activation configuration information. The processing module 402 can be configured to set the beam state over the at least one time unit based on the activation configuration information.

In some possible implementations, the first indication information can be carried in RRC signaling.

In some possible implementations, the first beam can be associated with a plurality pieces of activation configuration information. Each piece of activation configuration information can be configured for indicating the beam state of the first beam over at least one time unit. The first indication information can be configured for indicating one or more pieces of first activation configuration information in the plurality of pieces of activation configuration information. The processing module 402 can be configured to set the beam state over the at least one time unit based on the one or more pieces of first activation configuration information.

In some possible implementations, the first indication information can be carried in a MAC CE or DCI.

In some possible implementations, the activation configuration information can include at least one of: a pattern; an effective moment of the pattern; or an effective duration of the pattern.

In some possible implementations, the processing module 402 can also be configured to set an initial beam state of the first beam to an activated state or a deactivated state.

It should be noted that the specific implementation processes of the receiving module 401 and the processing module 402 can be referred to the detailed description of the relay device in the embodiment shown in FIG. 2. For the sake of brevity in this specification, they will not be repeated here.

The receiving module 401 referred to in embodiments of the present disclosure may be a receiving interface, a receiving circuit, or a receiver, etc.; and the processing module 402 may be one or more processors.

Based on the same inventive concept, embodiments of the present disclosure also provide a relay communication device. The device may be a network device (e.g., a gNB) in the above-described communication system or a chip or a system-on-a-chip in the network device, and may also be a functional module in the network device for realizing the method described in the above embodiments. The device may realize functions performed by the network device in the above embodiments, and these functions may be realized by hardware executing corresponding software. Such hardware or software includes one or more modules corresponding to the above-described functions. FIG. 5 shows a schematic diagram of a structure of a relay communication device according to embodiments of the present disclosure. As shown in FIG. 5, the relay communication device 500 may include a processing module 501 and a sending module 502. The processing module 501 is configured to determine a beam state of a first beam of a relay device. The sending module 502 is configured to send first indication information to the relay device, wherein the first indication information is configured for indicating the beam state.

In some possible implementations, the beam state can be an activated state or a deactivated state; and the activated state indicates that a beam is available for transmission and the deactivated state indicates that a beam is not available for transmission.

In some possible implementations, when the beam state is the deactivated state, the first beam is not included in beam indication information sent by the network device; or the first beam is not included in the beam indication information sent by the network device within a first duration.

In some possible implementations, the first beam can include at least one of: one or more beams and/or one or more beam groups of a backhaul link of the relay device; one or more beams and/or one or more beam groups of a control link of the relay device; or one or more beams and/or one or more beam groups of an access link of the relay device.

In some possible implementations, the first indication information can be configured for indicating a change in setting the beam state from a first state to a second state, the first state being different from the second state.

In some possible implementations, the first indication information can be configured for indicating a setting of the beam state to a third state.

In some possible implementations, the first indication information can be carried in the DCI.

In some possible implementations, the first beam can be associated with activation configuration information. The activation configuration information can be configured for indicating the beam state of the first beam over at least one time unit. The first indication information can include the activation configuration information.

In some possible implementations, the first indication information can be carried in RRC signaling.

In some possible implementations, the first beam can be associated with a plurality pieces of activation configuration information. Each piece of activation configuration information can be configured for indicating the beam state of the first beam over at least one time unit. The first indication information can be configured for indicating one or more pieces of first activation configuration information in the plurality of pieces of activation configuration information.

In some possible implementations, the first indication information can be carried in a MAC CE or DCI.

In some possible implementations, the activation configuration information can include at least one of: a pattern; an effective moment of the pattern; or an effective duration of the pattern.

In some possible implementations, an initial beam state of the first beam can be an activated state or a deactivated state.

It should be noted that the specific implementation processes of the processing module 501 and the sending module 502 can be referred to the detailed description of the network device in the embodiment shown in FIG. 3. For the sake of brevity in this specification, they will not be repeated here.

The sending module 502 referred to in embodiments of the present disclosure may be a receiving interface, a receiving circuit, or a receiver, etc.; the processing module 501 may be one or more processors.

Based on the same inventive concept, embodiments of the present disclosure provide a communication device, which may be a relay device or a network device as described in one or more of the above embodiments. FIG. 6 is a schematic diagram of a structure of a communication device according to embodiments of the present disclosure. As shown in FIG. 6, the communication device 600, utilizing common computer hardware, includes a processor 601, a memory 602, a bus 603, an input device 604, and an output device 605.

In some possible implementations, the memory 602 may include computer storage media in the form of volatile and/or non-volatile memory, such as read-only memory and/or random access memory. The memory 602 may store operating systems, applications, other program modules, executable code, program data, user data, and the like.

The input device 604 may be used to input commands and information to the communication device. The input device 604 may be, for example, a keyboard or pointing device such as a mouse, trackball, touchpad, microphone, joystick, game pad, satellite television antenna, scanner, or the like. These input devices may be connected to the processor 601 via the bus 603.

The output device 605 may be used to output information for communication device. In addition to a monitor, the output device 605 may be other peripheral output device, such as a speaker and/or a printing device, which may also be connected to the processor 601 via the bus 603.

The communication device may be connected to a network, such as to a local area network (LAN), via the antenna 606. In a networked environment, computer-executed instructions stored in the control device may be stored in a remote storage device, rather than being limited to local storage.

When the processor 601 in the communication device executes the executable code or application program stored in the memory 602, the communication device executes the communication method on the relay device side or the network device side in the above embodiments, the specific execution processes of which can be referred to the above embodiments, and will not be repeated here.

In addition, computer-executed instructions for realizing the functions of the receiving module 401 and the processing module 402 in FIG. 4 may be stored in the memory 602. The functions/implementation processes of the receiving module 401 and the processing module 402 in FIG. 4 can all be realized by the processor 601 in FIG. 6 calling the computer-executed instructions stored in the memory 602, with reference to the relevant embodiments described above for the specific implementation processes and functions.

Furthermore, computer-executed instructions for realizing the functions of the processing module 501 and the sending module 502 in FIG. 5 may be stored in the memory 602. The functions/implementation processes of the processing module 501 and the sending module 502 in FIG. 5 can all be realized by the processor 601 in FIG. 6 calling the computer-executed instructions stored in the memory 602, with reference to the relevant embodiments described above for the specific implementation processes and functions.

Based on the same inventive concept, embodiments of the present disclosure provide a network device that is consistent with the relay device or network device in one or more of the above embodiments.

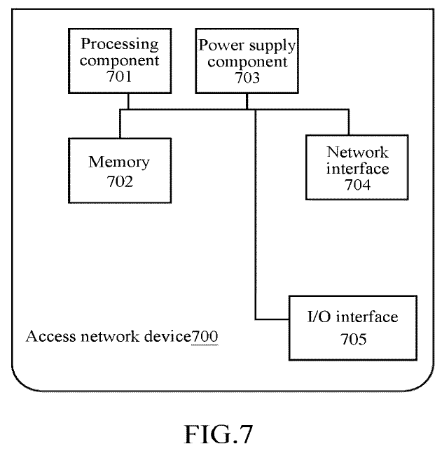

FIG. 7 is a schematic diagram of a structure of a network device according to embodiments of the present disclosure, Referring to FIG. 7, the network device 700 may include a processing component 701, which further includes one or more processors, and memory resources represented by a memory 702 for storing instructions, such as an application program, that may be executed by the processing component 801. The application programs stored in the memory 702 may include one or more modules each corresponding to a set of instructions. In addition, the processing component 701 is configured to execute instructions to perform any of the methods applied to the network device as described above.

The network device 700 may also include a power supply component 703 configured to perform power management of the network device 700, a wired or wireless network interface 704 configured to connect the network device 700 to a network, and an input/output (I/O) interface 705. The network device 700 may operate an operating system based on the operating system stored in the memory 702, such as Windows Server™, Mac OS X™, Unix™, Linux™, FreeBSD™ or the like.

Based on the same inventive concept, embodiments of the present disclosure also provide a computer-readable storage medium, the computer-readable storage medium having instructions stored therein; when the instructions are run on a computer, they are used to execute a communication method on the relay device side or the network device side of one or more embodiments described above.

Based on the same inventive concept, embodiments of the present disclosure also provide a computer program or a computer program product that, when the computer program product is executed on a computer, causes the computer to implement a communication method on the relay device side or the access network device side in one or more of the above embodiments.

Those skilled in the art, after considering the specification and practicing the invention disclosed here, will easily conceive of other embodiments of the present invention. This disclosure is intended to cover any modifications, uses, or adaptive changes of the invention, which follow the general principles of the invention and include commonly known knowledge or customary technical means in the technical field that are not explicitly disclosed in this disclosure. The specification and examples are to be regarded as exemplary only, and the true scope and spirit of the invention are indicated by the following claims.

It should be understood that the present invention is not limited to the precise structure which has been described above and illustrated in the accompanying drawings, and that various modifications and changes may be made without departing from its scope. The scope of the present invention is limited only by the appended claims.

What is claimed is:

1. A relay communication method, comprising:
receiving, by a relay device, first indication information from a network device, wherein the first indication information indicates a beam state of a first beam of the relay device; and
determining, by the relay device, the beam state of the first beam based on the first indication information.

2. The method according to claim 1, wherein the beam state is an activated state or a deactivated state; and wherein the activated state indicates that a beam is available for transmission and the deactivated state indicates that a beam is not available for transmission.

3. The method according to claim 2, wherein, when the beam state is the deactivated state, the method further comprises:
determining, by the relay device, that the first beam is not included in the beam indication information sent by the network device; or,
determining, by the relay device, that the first beam is not included in the beam indication information sent by the network device within a first duration.

4. The method according to claim 1, wherein the first beam comprises at least one of:
one or more beams and/or one or more beam groups of a backhaul link of the relay device;
one or more beams and/or one or more beam groups of a control link of the relay device; or
one or more beams and/or one or more beam groups of an access link of the relay device.

5. The method according to claim 1, wherein determining, by the relay device, the beam state of the first beam based on the first indication information comprises:
changing, by the relay device, the beam state of the first beam from a first state to a second state based on the first indication information, the first state being different from the second state.

6. The method according to claim 1, wherein determining, by the relay device, the beam state of the first beam based on the first indication information comprises:
setting, by the relay device, the beam state of the first beam to a third state based on the first indication information.

7. The method according to claim 1, further comprising:
determining, by the relay device, a second duration between the reception of the first indication information and the time when the beam state becomes effective on the first beam; or,
determining, by the relay device, a third duration between sending of an acknowledgement message for the first indication information and the time when the beam state becomes effective on the first beam.

8. The method according to claim 1, wherein the first beam is associated with activation configuration information, the activation configuration information indicating the beam state of the first beam over at least one time unit, and the first indication information comprises the activation configuration information; and
wherein determining, by the relay device, the beam state of the first beam based on the first indication information comprises:
setting, by the relay device, the beam state over the at least one time unit based on the activation configuration information.

9. The method according to claim 1, wherein the first beam is associated with a plurality pieces of activation configuration information, each piece of activation configuration information indicating the beam state of the first beam over at least one time unit, and the first indication information indicates one or more pieces of first activation configuration information in the plurality of pieces of activation configuration information;
wherein determining, by the relay device, the beam state of the first beam based on the first indication information comprises:
setting, by the relay device, the beam state over the at least one time unit based on the one or more pieces of first activation configuration information.

10. The method according to claim 8 or 9, wherein the activation configuration information comprises at least one of:
a pattern;
an effective moment of the pattern; or
an effective duration of the pattern.

11. The method according to claim 1, further comprising:
setting, by the relay device, an initial beam state of the first beam to an activated state or a deactivated state.

12. A relay communication method, comprising:
determining, by a network device, a beam state of a first beam of a relay device; and
sending, by the network device, first indication information to the relay device, wherein the first indication information indicates the beam state.

13. The method according to claim 12, wherein the beam state is an activated state or a deactivated state; and wherein the activated state indicates that a beam is available for transmission and the deactivated state indicates that a beam is not available for transmission.

14. The method according to claim 13, wherein, when the beam state is the deactivated state,
the first beam is not included in beam indication information sent by the network device; or
the first beam is not included in the beam indication information sent by the network device within a first duration.

15. The method according to claim 12, wherein the first beam comprises at least one of:
one or more beams and/or one or more beam groups of a backhaul link of the relay device;
one or more beams and/or one or more beam groups of a control link of the relay device; or
one or more beams and/or one or more beam groups of an access link of the relay device.

16. The method according to claim 12, wherein the first indication information indicates a change in setting the beam state from a first state to a second state, the first state being different from the second state.

17. The method according to claim 12, wherein the first indication information indicates a setting of the beam state to a third state.

18. The method according to claim 12, wherein the first beam is associated with activation configuration information, the activation configuration information indicating the beam state of the first beam over at least one time unit, and the first indication information comprises the activation configuration information.

19. The method according to claim 12, wherein the first beam is associated with a plurality pieces of activation configuration information, each piece of activation configuration information indicating the beam state of the first beam over at least one time unit, and the first indication information indicates one or more pieces of first activation configuration information in the plurality of pieces of activation configuration information.

20. The method according to claim 18 or 19, wherein the activation configuration information comprises at least one of:
a pattern;
an effective moment of the pattern; or
an effective duration of the pattern.

21. The method according to claim 12, wherein an initial beam state of the first beam is an activated state or a deactivated state.

22. A relay communication device, comprising:
a receiving module configured to receive first indication information from a network device, wherein the first indication information indicates a beam state of a first beam of a relay device; and
a processing module configured to determine the beam state of the first beam based on the first indication information.

23. A relay communication device, comprising:
a processing module configured to determine a beam state of a first beam of a relay device; and
a sending module configured to send first indication information to the relay device, wherein the first indication information indicates the beam state.

24. An electronic device, comprising:
a memory; and
a processor connected to the memory and configured to execute computer-executable instructions stored on the memory to perform the method according to any one of claims 1 to 11 or claims 12 to 21.

25. A computer storage medium, storing computer-executable instructions which, when executed by a processor, cause the processor to perform the method according to any one of claims 1 to 11 or claims 12 to 21.
